(19) United States
(12) Patent Application Publication
(10) Pub. No.: US 2005/0161945 A1
(43) Pub. Date: Jul. 28, 2005

(54) Cantilever wind-exhausting pipe

(75) Inventor: Chieh yuan Cheng, Taichung (TW)

Correspondence Address: TROXELL LAW OFFICE PLLC, SUITE 1404, 5205 LEESBURG PIKE, FALLS CHURCH, VA, 22041, US

(73) Assignee: San Ford Machinery Co., Ltd.

(21) Appl. No.: 10/762,247

(22) Filed: Jan. 23, 2004

(51) Int. Cl. F16L 27/00

(52) U.S. Cl. 285/184; 285/226

(57) ABSTRACT

A cantilever wind-exhausting pipe includes plural inflexible pipes, plural flexible pipes and plural joint members respectively provided between every two inflexible pipes to be pivotally turned to adjust the wind port of a lowermost inflexible pipe to a proper position. The joint member is provided with a torsion spring fitted on a pivotal bolt connecting two sets of connecting plates. The torsion spring has its opposite ends respectively pressing the two sets of connecting plates and compensating the gravity of the lower inflexible pipes. When a frictional force between the two sets of connecting plates and friction rings positioned therebetween is somewhat adjusted in advance, the lower inflexible pipes will be kept in place not to move downward, able to freely and quickly adjust the wind port of the lowermost inflexible pipe to any position.

### BACKGROUND OF THE INVENTION

1. Field of the Invention

This invention relates to a cantilever wind-exhausting pipe, particularly to one able to precisely and stably adjust its wind port to a position needed for wind exhausting, convenient to be adjusted with little labor and with quickness.

2. Description of the Prior Art

An adjustable cantilever wind-exhausting pipe is commonly used at various places, such as an electron laboratory, an elementary training school, a chemical engineering organization or a barbershop. A conventional cantilever wind-exhausting pipe 10, as shown in FIGS. 1 and 2, includes a plurality of inflexible pipes 11, and the uppermost inflexible pipe 11 is fixed on a wall and connected with a wind-exhausting device (not shown). A joint member 12 is provided between every two inflexible pipes 11, having two adapters for respectively fitting the inflexible pipe 11 and two hollow pivotal couplers 121 to be oppositely combined together. The joint member 12 is provided with a friction ring 122 sandwiched between the two pivotal couplers 121 and an elongate bolt 123 inserted through the two pivotal couplers 121, having its end fitted with a ball bearing 124 and screwed with an adjustable locking member 125. When the adjustable locking member 125 is screwed tight, the two pivotal couplers 121 will be closely combined together, thus producing a frictional effect between the two pivotal couplers 121 and the friction ring 122.

To adjust the wind port 111 of the multi-sectioned conventional wind-exhausting pipe 10 to face a position needed for wind exhausting, some or all of the adjustable locking members 125 are unscrewed one by one and one or some of the inflexible pipes 11 are turned to make the wind port 111 face a needed direction, and then the adjustable locking members 125 are screwed tight to finish adjustment.

As can be noted from the above description, the conventional multi-sectioned wind-exhausting pipe 10 has the following defects.

1. To turn the joint members 12 to adjust the wind port 111 to face a position needed for wind exhausting, firstly, the adjustable locking members 125 of the joint members 12 have to be orderly and respectively unscrewed, secondly the joint members 12 have to be turned one by one and lastly, and lastly the adjustable locking members 125 have to be screwed tight, complicated in operation of adjustment and unable to quickly adjust the wind port 111 to precisely face a position needed for wind exhausting.

2. The joint members 12 of the cantilever multi-sectioned wind-exhausting pipe 10 are usually located too high for a user to adjust directly; therefore the user has to stand on a table, a chair or the like so as to carry out adjustment of the joint members 12, resulting in much inconvenience in adjustment.

### SUMMARY OF THE INVENTION

The objective of the invention is to offer a cantilever wind-exhausting pipe provided with plural joint members respectively assembled between every two inflexible pipes and each joint member is provided with a torsion spring fitted on a pivotal bolt. The torsion spring has its opposite ends respectively pressing two sets of connecting plates to cancel the gravity of the lower inflexible pipes, able to quickly turn the joint members with little force and precisely and stably adjust the wind port of the lowermost inflexible pipe to face a direction+needed for wind exhausting.

### BRIEF DESCRIPTION OF DRAWINGS

This invention will be better understood by referring to the accompanying drawings, wherein:

FIG. 1 is a perspective view of a conventional cantilever wind-exhausting pipe:

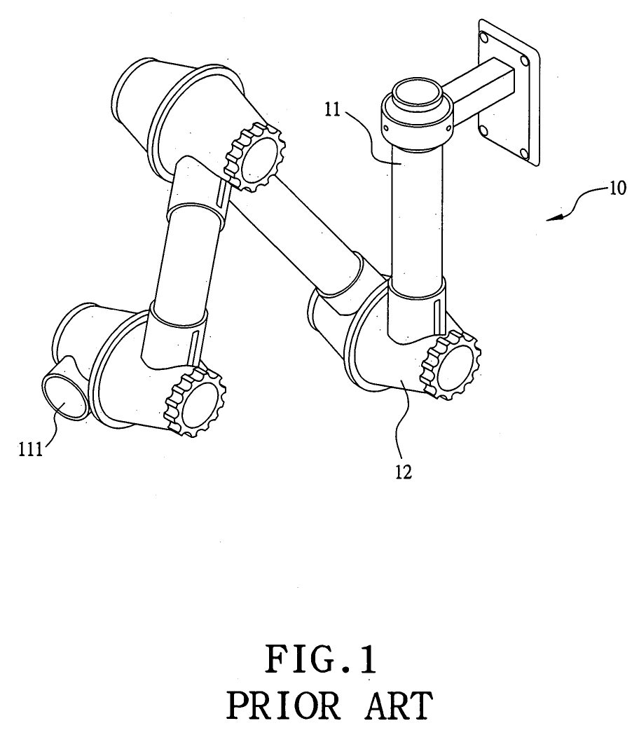

FIG. 2 is an exploded perspective view of a joint member of the conventional cantilever wind-exhausting pipe:

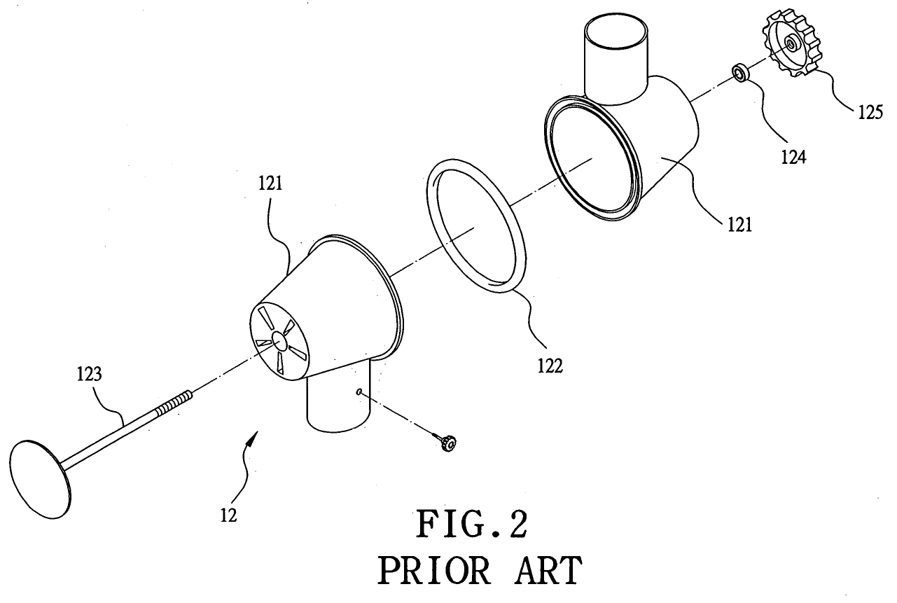

FIG. 3 is a cross-sectional view of a cantilever wind-exhausting pipe in the present invention:

FIG. 4 is a partial exploded perspective view of a joint member of the cantilever wind-exhausting pipe in the present invention:

FIG. 5 is a side cross-sectional view of the joint member of the cantilever wind-exhausting pipe in the present invention:

FIG. 6 is a cross-sectional view of the cantilever wind-exhausting pipe assembled with a transport pipe fixed on a wall in the present invention:

FIG. 7 is a cross-sectional view of the cantilever wind-exhausting pipe adjusted in position in the present invention: and

FIG. 8 is a cross-sectional view of the cantilever wind-exhausting pipe additionally provided with a control valve, a freely turned joint member and a wind port shade in the present invention.

### DETAILED DESCRIPTION OF THE PREFERRED EMBODIMENT

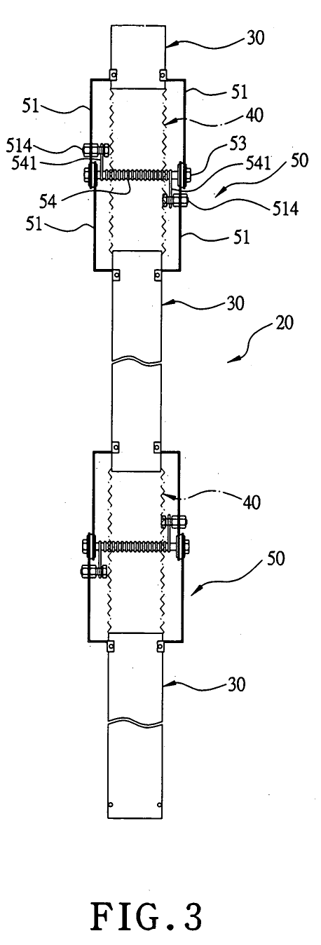

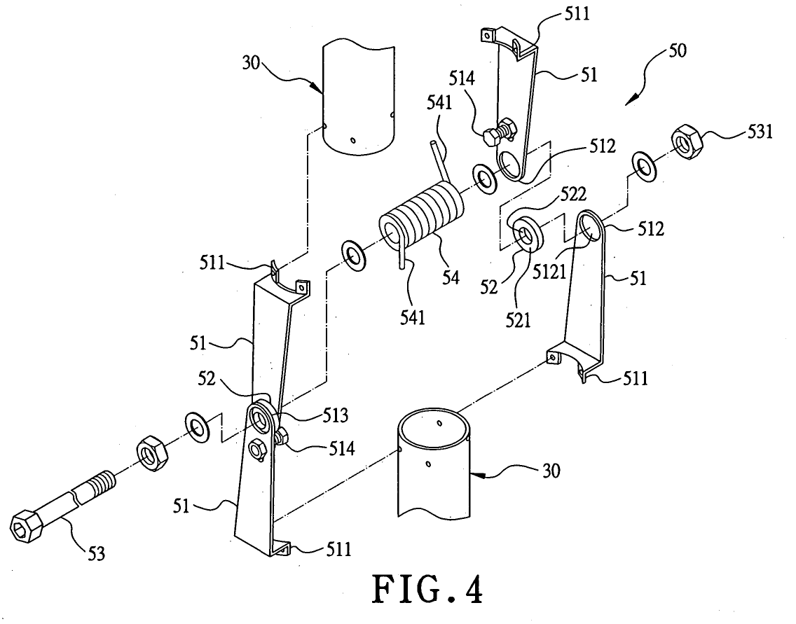

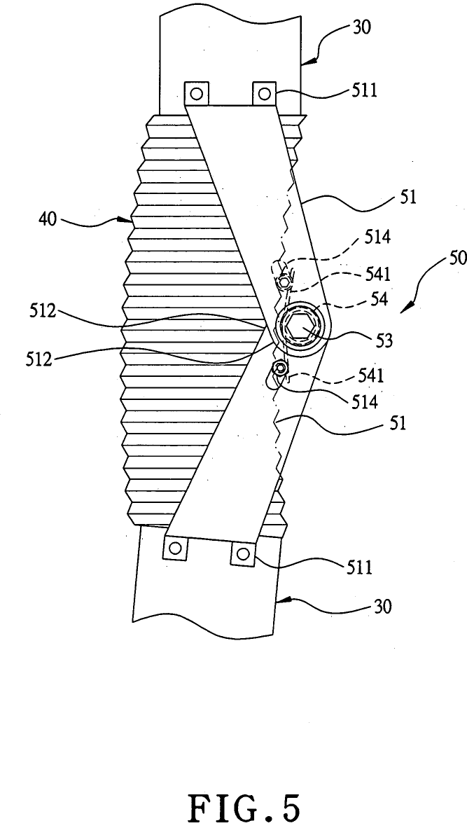

A preferred embodiment of a cantilever wind-exhausting pipe 20 in the present invention, as shown in FIGS. 3, 4 and 5, includes plural inflexible pipes 30, plural flexible pipes 40 and plural joint members 50 as main components combined together.

The joint members 50 are respectively provided between every two inflexible pipes 30, able to be pivotally turned and adjusted. Each joint member 50 consists of two sets of connecting plates 51, two friction blocks 52, a pivotal bolt 53 and a torsion spring 54.

Each set of connecting plates 51 includes two plates respectively formed with a fixing end 511 bent vertically and a pivotal connecting end 512. The upper set of connecting plates 51 has its two fixing ends 11 respectively and symmetrically secured on the lower outer wall of an upper inflexible pipe 30, letting its two lower pivotal connecting ends 512 separated from each other at a comparatively long distance. The lower set of connecting plates 51 has its two fixing ends 511 respectively and symmetrically secured on the upper outer wall of a lower inflexible pipe 30, letting its two pivotal connecting ends 512 separated from each other at a comparatively short distance. Thus, the lower set of connecting plates 51 is positioned at the inner side of the upper set of connecting plates 51 and separated from each other at a proper distance to form an accommodating gap 513 therebetween. Each connecting plate 51 has its pivotal connecting end 512 bored with a pivot hole 5121, and one upper connecting plate 51 and one opposite lower connecting plate 51 are respectively fixed with a bolt-shaped stop member 514 on the inner wall near the pivotal connecting end 512.

Two friction rings 52 are respectively received in the two accommodating gaps 513 formed between the two opposite pivotal connecting ends 512 of the two sets of connecting plates 51. Each friction ring 52 has its opposite sides respectively formed with a friction surface 521 to contact with the walls of the opposite pivotal connecting ends 512 and produce a frictional force to prevent the connecting plates 51 from turning pivotally. Further, each friction ring 52 is bored with an insert hole 522 in the center.

The pivotal bolt 53 is inserted through both the pivot holes 5121 of the pivotal connecting ends 512 of the two sets of connecting plates 51 and the insert holes 522 of the friction blocks 52, having its outer end screwed with a nut 531 to let the pivotal connecting ends 512 of the connecting plates 51 and the frictional surfaces 521 of the friction block 52 clamped with each other to produce a proper frictional force for fixing the two sets of connecting plates 51 in position.

The torsion spring 54 is fitted around an intermediate portion of the pivotal bolt 53 and has its opposite ends 541 respectively pushing against the two stop members 514 on the inner sides of the two sets of connecting plates 51 to press the two sets of connecting plates 51 with its elastic torsion. The elastic torsion of the torsion spring 54 is able to resist the gravity produced by the lower inflexible pipes 30 and supply the lower inflexible pipes 30 with an auxiliary supporting force.

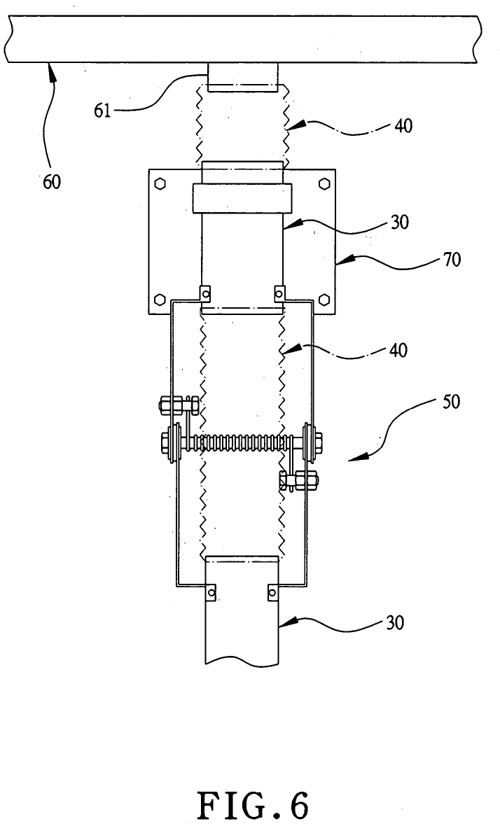

The cantilever wind-exhausting pipe 20 of this invention can be installed on a wall of a laboratory or on certain portion of a worktable or the like. For instance, as shown in FIG. 6, to install the cantilever wind-exhausting pipe 20 on a wall, a wind-exhausting device serving as a dust-collecting machine is provided in advance, which is usually installed outdoors so as to diminish noises caused by its operation, and a transport pipe 60 is provided in a room and connected with the dust-collecting machine, having a number of adapters 61 provided at proper locations. Subsequently, the cantilever wind-exhausting pipe 20 in this invention has its uppermost inflexible pipe 30 fitted with the adapter 61 of the transport pipe 60 by means of a flexible pipe 40. In order to install the cantilever wind-exhausting pipe 20 stably on a wall, a fixing base 70 is additionally secured on the wall for the uppermost inflexible pipe 30 to be movably fitted thereon so as to firmly position the cantilever wind-exhausting pipe 20 on the wall, preventing the uppermost in flexible pipe 30 from disengaged from the transport pipe 60 and making the uppermost inflexible pipe 30 adjustable on the fixing base 70.

Next, each joint member 50 has its turning tightness adjusted to a proper extent. Since the gravity of each lower inflexible pipe 30 is compensated by the elastic torsion of the torsion spring 54, it needs only a little frictional force between the pivotal connecting ends 512 of the connecting plates 51 and the friction rings 52 to prevent each lower in flexible pipe 30 from falling downward by its own gravity. Therefore, the turning frictional force between the pivotal connecting ends 512 of the connecting plates 51 and the friction ring 52 has to be first adjusted to an extent a little larger than the absolute value of the difference between the elastic torsion of the torsion spring 54 and the gravity of the lower inflexible pipe 30, and then the joint members 50 are respectively locked in position, with the least force needed in adjustment.

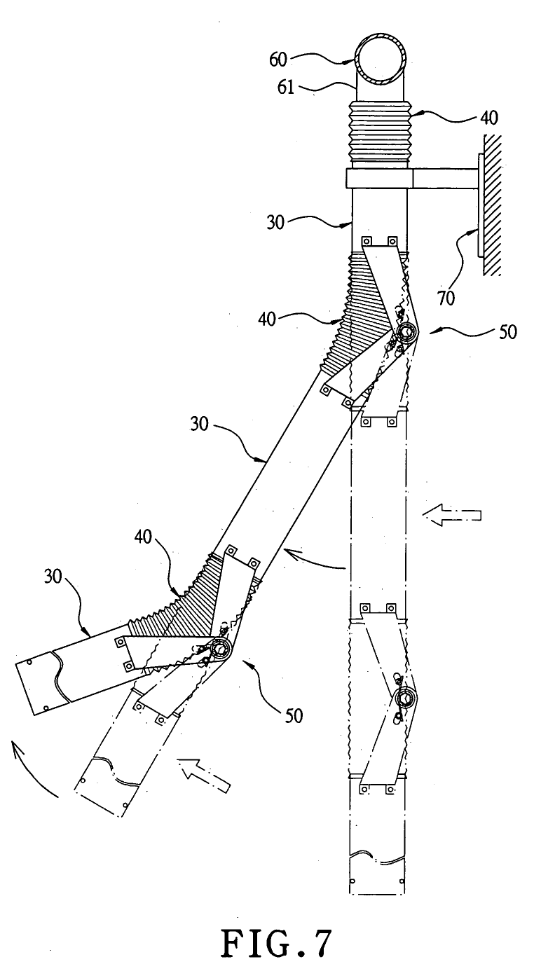

To adjust the wind port 31 of the lowermost inflexible pipe 30 of the cantilever wind-exhausting pipe 20 to face a position needed for wind exhausting, as shown in FIG. 7, only move a specific inflexible pipe 30 with a force a little larger than the turning frictional force between the pivotal connecting ends 512 and the friction ring 52 to make the two sets of connecting plates 51 of the joint member 50 turned relatively and adjust the lower inflexible pipes 30 to let the wind port 31 of the lowermost inflexible pipe 30 face a needed position. Evidently, the wind port 31 of the lowermost inflexible pipe 30 of the cantilever wind-exhausting pipe 20 in the present invention can freely and quickly be adjusted to any location and positioned stably, requiring no step of unscrewing and locking of certain component as needed in the conventional cantilever wind-exhausting pipe.

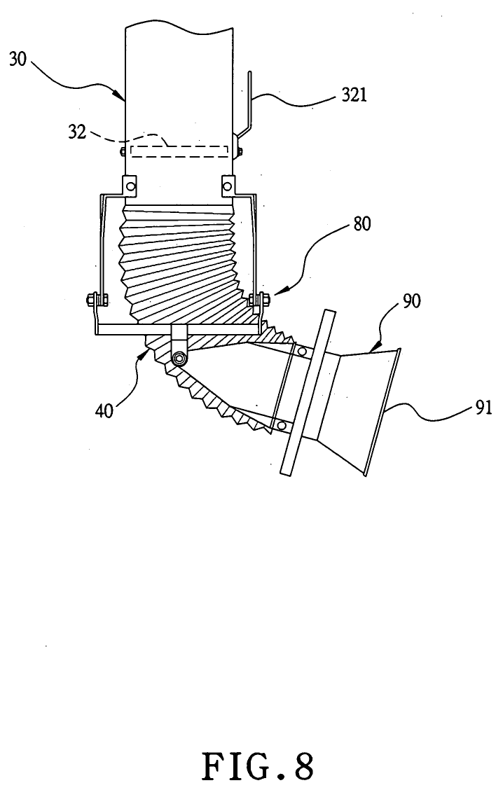

Further, to elevate efficiency of controlling wind exhausting of the cantilever wind-exhausting pipe 20 of this invention, as shown in FIG. 8, the lowermost inflexible pipe 30 has its interior provided with a valve 32 at a preset position and its outer side provided with a control handle 321 to be connected with and control the valve 32 to open and close the wind passage of the wind-exhausting pipe 20 and regulate wind flow, convenient in handling and able to meet different requirements in wind pumping.

Furthermore, in order to freely and precisely adjust the wind port 31 to a needed position, the lowermost inflexible pipe 30 has its lower and fixed with a bendable joint member 80 having its outer end connected with a trumpet-shaped wind-exhausting shade 90, with bellows 40 fitted between the lowermost inflexible pipe 30 and the wind port shade 90, enabling the wind port 91 of the wind-exhausting shade 90 to be freely and quickly adjusted to any location needed for wind exhausting.

While the preferred embodiment of the invention has been described above, it will be recognized and understood that various modifications may be made therein and the appended claims are intended to cover all such modifications that may fall within the spirit and scope of the invention.

1. A cantilever wind-exhausting pipe comprising plural inflexible pipes and plural flexible pipes, said in flexible pipes respectively connected with said flexible pipes, a joint member provided between every two of said inflexible pipes, said joint member enabling each lower said inflexible pipe to be turned pivotally, said joint members respectively comprising two sets of connecting plates, two friction rings, a pivotal bolt and a torsion spring:
Said two sets of connecting plates respectively comprising two connecting plates, each said connecting plate formed with a fixing end and a pivotal connecting end, said two fixing ends of said two connecting plates respectively and symmetrically secured on the outer walls of two opposite said inflexible pipes located up and down, said pivotal connecting ends respectively bored with a pivot hole, said two sets of connect plates respectively having one said plate of opposite sides fixed with a stop member on an inner wall near said pivotal connecting end:
Said two friction rings respectively sandwiched between two said pivotal connecting ends of said two sets of connecting plates, each said friction ring having its opposite sides respectively formed with a friction surface, said friction surfaces closely pushing against the walls of said two pivotal connecting ends of said two connecting plates and producing a turning frictional force, each said friction ring bored with an insert hole in the center:
Said pivotal bolt inserted through both said shaft holes of said two set of connecting plates and said insert holes of said two friction rings, said pivotal bolt having its end screwed with a nut to closely tighten said pivotal connecting ends of said connecting plates together with said friction rings, a turning frictional force able to be produced between said pivotal connecting ends and said friction blocks: and,
Said torsion spring fitted around an intermediate portion of said pivotal bolt, said torsion spring having its opposite ends respectively pushing against said stop members on the inner sides of said two sets of connecting plates, said two sets of connecting plates pressed by the elastic torsion of said torsion spring, said elastic torsion of said torsion spring properly compensating the gravity of the lower said inflexible pipes.

2. The cantilever wind-exhausting pipe as claimed in claim 1, wherein said stop member is a locking bolt.

3. The cantilever wind-exhausting pipe as claimed in claim 1, wherein said lowermost inflexible pipe is connected with a wind-exhausting shade by means of a bendable joint member, with bellows fitted between said lowermost inflexible pipe and said wind-exhausting shade.

4. The cantilever wind-exhausting pipe as claimed in claim 1, wherein said lowermost inflexible pipe is provided with a valve at a preset location in its interior and a control handle connected with said valve at its outer side to control said valve to open and close the wind passage of said wind-exhausting pipe.

5. The cantilever wind-exhausting pipe as claimed in claim 1, wherein said cantilever wind-exhausting pipe is connected with a wind-exhausting device which is composed of a dust-collecting machine and a transport pipe, said transport pipe provided thereon with at least one adapter connected directly or indirectly with said uppermost inflexible pipe.
